(19) United States
(12) Patent Application Publication
(10) Pub. No.: US 2023/0333918 A1
(43) Pub. Date: Oct. 19, 2023

(54) AUTOMATED SERVICE ARRANGEMENT AND EXECUTION SYSTEM AND METHOD THEREOF

(71) Applicants: Digiwin Software Co., Ltd, Shanghai (CN); DATA SYSTEMS CONSULTING CO., LTD., New Taipei City (TW)

(72) Inventors: Lei Feng, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 17/838,293

(22) Filed: Jun. 13, 2022

(30) Foreign Application Priority Data
Apr. 18, 2022 (CN) 202210402202.3

(51) Int. Cl. G06F 9/54; G06F 9/48

(52) U.S. Cl. CPC G06F 9/541; G06F 9/546; G06F 9/4856; G06F 9/4881

(57) ABSTRACT

An automated service arrangement and execution system and an automated service arrangement and execution method are provided. The automated service arrangement and execution system includes a storage device and a processor. The storage device stores a data relationship obtaining and parsing module, a calling route planning module, and an execution module. The processor executes multiple modules and receives request data for executing an application programming interface (API). The data relationship obtaining and parsing module creates a calling model according to the request data. The calling model includes multiple API objects and the API, and the calling route planning module establishes a calling path according to the API objects and relationship information between respective multiple input data of the API and input data sources. The execution module executes the API objects and the API in the calling model according to the calling path to generate an execution result of the API.

### CROSS-REFERENCE TO RELATED APPLICATION

This application claims the priority benefit of China application serial no. 202210402202.3, filed on Apr. 18, 2022. The entirety of the above-mentioned patent application is hereby incorporated by reference herein and made a part of this specification.

### BACKGROUND

### Technical Field

The disclosure relates to an execution mode of an application program interface, and in particular, to an automated service arrangement and execution system and a method thereof.

### Description of Related Art

An application program for providing (business) services usually provides an application programming interface (API) with specific capabilities, so as to provide functional services externally. However, in order to realize a certain business behavior, a system or user usually calls a specific API to obtain the desired output result (business data). A common situation is that before the system or user calls the specific API, the system or user needs to construct the input data of the specific API. However, the input data of the specific API is actually the output results generated by the sequential execution of another or other APIs. Therefore, if the another API has not been executed to generate the output result, the specific API also cannot generate the desired output result.

### SUMMARY

The disclosure relates to an automated service arrangement and execution system and a method thereof, which may automatically arrange the execution sequence of multiple application programming interfaces (APIs) according to request data, so as to automatically generate corresponding business data.

According to an embodiment of the disclosure, the automated service arrangement and execution system of the disclosure includes a storage device and a processor. The storage device stores multiple modules. The processor is coupled to the storage device. The processor executes the modules and receives request data for executing an API. The modules include a data relationship obtaining and parsing module, a calling route planning module, and an execution module. The data relationship obtaining and parsing module creates a calling model according to the request data. The calling model includes multiple API objects and the API. The calling route planning module establishes a calling path according to the API objects and the relationship information between respective multiple input data of the API and multiple input data sources. The execution module executes the API objects and the API in the calling model according to the calling path, so as to generate an execution result of the API.

According to an embodiment of the disclosure, the automated service arrangement and execution method of the disclosure includes the following steps: request data for executing an API is received; a calling model is created by a data relationship obtaining and parsing module according to the request data, and the calling model includes multiple API objects and the API; a calling path is established by a calling route planning module according to the API objects and the relationship information between respective multiple input data of the API and multiple input data sources; and the API objects and the API in the calling model are executed by an execution module according to the calling path, so as to generate an execution result of the API.

Based on the above, the automated service arrangement and execution system and the method thereof of the disclosure may automatically establish the calling path of the API objects and the API according to the request data, and automatically generate results of the API objects and the API.

In order to make the above-mentioned features and advantages of the disclosure comprehensible, embodiments accompanied with drawings are described in detail as follows.

### BRIEF DESCRIPTION OF THE DRAWINGS

FIG. 1 is a schematic diagram of an automated service arrangement and execution system according to an embodiment of the disclosure.

FIG. 2 is a flowchart of an automated service arrangement and execution method according to an embodiment of the disclosure.

FIG. 3 is a schematic diagram of execution of multiple modules according to an embodiment of the disclosure.

FIG. 4 is a flowchart of calling path planning analysis according to an embodiment of the disclosure.

FIGS. 5A and 5B are flowcharts of execution logic of an embodiment of the disclosure.

FIG. 6 is a schematic diagram of a calling model according to an embodiment of the disclosure.

### DESCRIPTION OF THE EMBODIMENTS

Reference is now made in detail to exemplary embodiments of the disclosure, and examples of the exemplary embodiments are illustrated in the accompanying drawings. Wherever possible, the same reference numerals are used in the drawings and descriptions to refer to the same or similar parts.

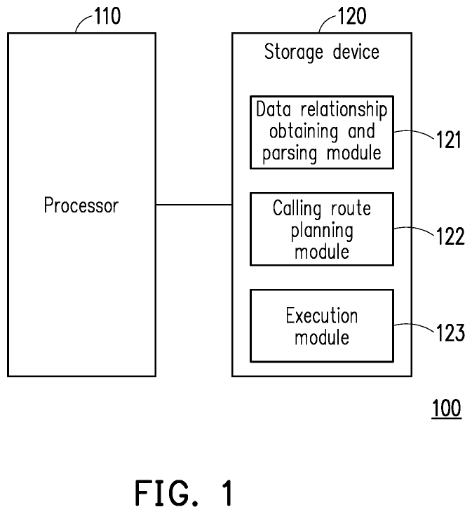

FIG. 1 is a schematic diagram of an automated service arrangement and execution system according to an embodiment of the disclosure. Referring to FIG. 1, an automated service arrangement and execution system 100 includes a processor 110 and a storage device 120. The processor 110 is coupled to the storage device 120. The storage device 120 stores a data relationship obtaining and parsing module 121, a calling route planning module 122, and an execution module 123. In the embodiment, the automated service arrangement and execution system 100 may be, for example, disposed on a cloud server for a user to connect and execute related business service functions of different application programming interfaces (APIs) that are also disposed on the cloud server. The cloud server may be, for example, a software as a service (SaaS) server, and the API corresponds to a SaaS application, but the disclosure is not limited thereto. Alternatively, in an embodiment, the automated service arrangement and execution system 100 may be disposed in an enterprise resource planning (ERP) system run by a local server inside an enterprise, so as to provide related business service functions (e.g., business services such as generating purchase orders, purchase requisitions, quotations, etc.) through different APIs.

In the embodiment, the processor 110 may include, for example, a central processing unit (CPU), or other programmable general-purpose or special-purpose microprocessors, digital signal processors (DSPs), application specific integrated circuits (ASICs), programmable logic devices (PLDs), other similar processing circuits, or combinations thereof. The storage device 120 may include a memory and/or a database, and the memory may be, for example, a non-volatile memory (NVM). The storage device 120 may store related programs, modules, systems, or algorithms useful for implementing various embodiments of the disclosure for the access and execution of the processor 110, so as to implement the related functions and operations described in the various embodiments of the disclosure. In the embodiment, the data relationship obtaining and parsing module 121, the calling route planning module 122, and the execution module 123 may be implemented with, for example, programming languages such as JavaScript Object Notation (JSON), Extensible Markup Language (XML), or YAML Ain′t Markup Language (YAML), but the disclosure is not limited thereto.

In the embodiment, the user may, for example, execute the automated service arrangement and execution system 100 through a personal computer device, and input request data into the automated service arrangement and execution system 100 to request the execution of the corresponding API. The automated service arrangement and execution system 100 may automatically execute the data relationship obtaining and parsing module 121, the calling route planning module 122, and the execution module 123 according to the request data to automatically generate a corresponding execution result (business data). In the embodiment, the user may execute a (specific) API, and since the API processing logic of the API needs to generate an execution result of one or more corresponding output data according to one or more input data. As the input data are one or more output data of another or other APIs (i.e., API objects), the automated service arrangement and execution system 100 may automatically create a calling model including the another or the other APIs (i.e., the API objects). The automated service arrangement and execution system 100 may automatically execute the another or the other APIs (i.e., the API objects) in the calling model according to the corresponding calling sequence, so as to automatically generate the corresponding execution result (business data).

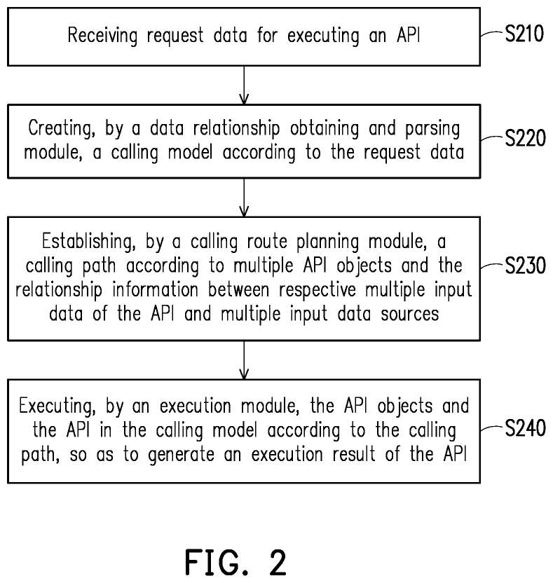

FIG. 2 is a flowchart of an automated service arrangement and execution method according to an embodiment of the disclosure. Referring to FIGS. 1 and 2, the automated service arrangement and execution system 100 may execute the following steps S210 to S240 to automatically generate the corresponding execution result. In the embodiment, the user may input the request data into the automated service arrangement and execution system 100 to execute the (specific) API. In step S210, the processor 110 may receive the request data for executing the API. In step S220, the processor 110 may create the calling model according to the request data through the data relationship obtaining and parsing module 121. In the embodiment, the data relationship obtaining and parsing module 121 may execute data structure analysis of the request data and model obtaining of a data relationship. The data relationship obtaining and parsing module 121 may parse the model obtaining of the data relationship, and may create one or more API objects that may be configured for execution according to the parsing result.

In step S230, the processor 110 may establish a calling path according to the API objects and the relationship information between respective multiple input data of the API and multiple input data sources through the calling route planning module 122. In the embodiment, when the input data has a dependency relationship with the input data sources, the calling route planning module 122 may establish the dependency relationship between the API objects and the input data sources. When the input data has multiple input data sources with equivalent business meanings, the calling route planning module 122 may confirm the acquisition (execution) sequence of the input data sources. In the embodiment, the API objects and the API are different business APIs, and the execution result of the API is business data.

In step S240, the processor 110 may execute the API objects and the API in the calling model according to the calling path through the execution module 123, so as to generate the execution result of the API. In the embodiment, the execution module 123 may execute the API object, and construct the input data of the API object, so as to acquire corresponding data according to the dependency relationship between the input data and the input data source or execute other API objects that output the data source to obtain the corresponding data. The execution module 123 may automatically explore and execute the API objects according to the calling path. When the input data has multiple peer data sources, the execution module 123 may select one of the input data sources to acquire data according to the calling sequence of the input data sources. When the data acquisition fails, the execution module 123 may replace the execution data source. The execution module 123 may determine the calling manner of the API objects according to the input data structure, such as one call or multiple calls.

In this way, the automated service arrangement and execution system and the method thereof of the disclosure may automatically establish the API objects and the calling paths of the API objects according to the request data, and may automatically execute the API objects and the API sequentially according to the calling paths, so as to automatically generate expected business data.

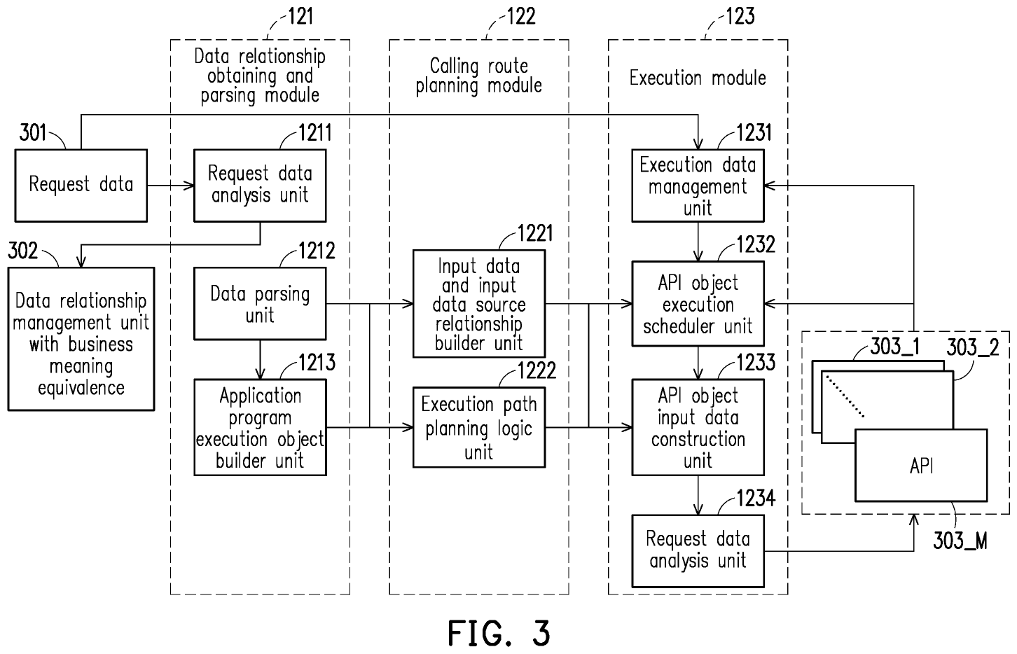

FIG. 3 is a schematic diagram of execution of multiple modules according to an embodiment of the disclosure. Referring to FIGS. 1 and 3, the data relationship obtaining and parsing module 121 includes a request data analysis unit 1211, a data parsing unit 1212, and an application program execution object builder unit 1213. The calling route planning module 122 includes an input data and input data source relationship builder unit 1221 and an execution path planning logic unit 1222. The execution module 123 includes an execution data management unit 1231, an API object execution scheduler unit 1232, an API object input data construction unit 1233, and an API execution agent unit 1234. The calling model may include an API 303_1 and multiple API objects 303_2 to 303_M, where M is a positive integer.

In the embodiment, the request data analysis unit 1211 may analyze the data relationship between the known data and the API 303_1 according to request data 301 to obtain an attribute field, and provide the attribute field to a data relationship management unit with business meaning equivalence 302 to obtain the data relationship between the attribute field and the API. The data parsing unit 1212 may analyze the data relationship for executing the API 303_1 to identify respective API object and input structure definitions of the API objects 303_2 to 303_M and the API object input parameter and data source relationships. The application program execution object builder unit 1213 may construct multiple API objects 303_2 to 303_M according to the respective API object and input structure definitions of the API objects 303_2 to 303_M and the API object input parameter and data source relationships.

In the embodiment, the API object and input structure definitions include at least one of an API object name, an API access method, an API access address, an input parameter structure, an input parameter data hierarchy, and an input parameter field name. The API object input parameter and data source relationships include at least one of the API object name, a subordinate relationship between an input parameter field and the API object, the input parameter field name, a hierarchical description of the input parameter field in the input parameter structure, a field name of the data corresponding to the input parameter field in the data source, a data source name, and a hierarchical description in the data source of the field in the data source.

In the embodiment, the respective API object input parameter and data source relationships between the API objects 303_2 to 303_M and the input data include an API name of the API object, a subordinate relationship between an API input data field and the API object, an API input data name, a hierarchical description of the API input data field in the input data structure, a field name of the API input data field in the corresponding input data resource, the name of the input data source, and a hierarchical description in the input data source of the field in the input data source.

In the embodiment, the input data and input data source relationship builder unit 1221 may establish relationships between the API objects 303_2 to 303_M and input data field definition objects and relationships between the input data field definition objects and the input data sources according to the respective API object and the input structure definitions of the API objects 303_2 to 303_M and the API object input parameter and the data source relationships. The execution path planning logic unit 1222 may sort the input data sources according to a preset rule to establish the calling path. When the input data sources are multiple, the execution path planning logic unit 1222 may try to execute the input data sources in order of the highest priority until data is acquired.

In the embodiment, the execution data management unit 1231 may store the request data, and store multiple output data generated by the API objects 303_2 to 303_M and the API 303_1. The API object execution scheduler unit 1232 may schedule the API objects 303_2 to 303_M according to the calling path. The API object input data construction unit 1233 may construct multiple input data fields according to the API objects 303_2 to 303_M. The API execution agent unit 1234 may initiate calls of the API objects 303_2 to 303_M and the API 303_1, and collect the output data generated by the API objects 303_2 to 303_M and the API 303_1.

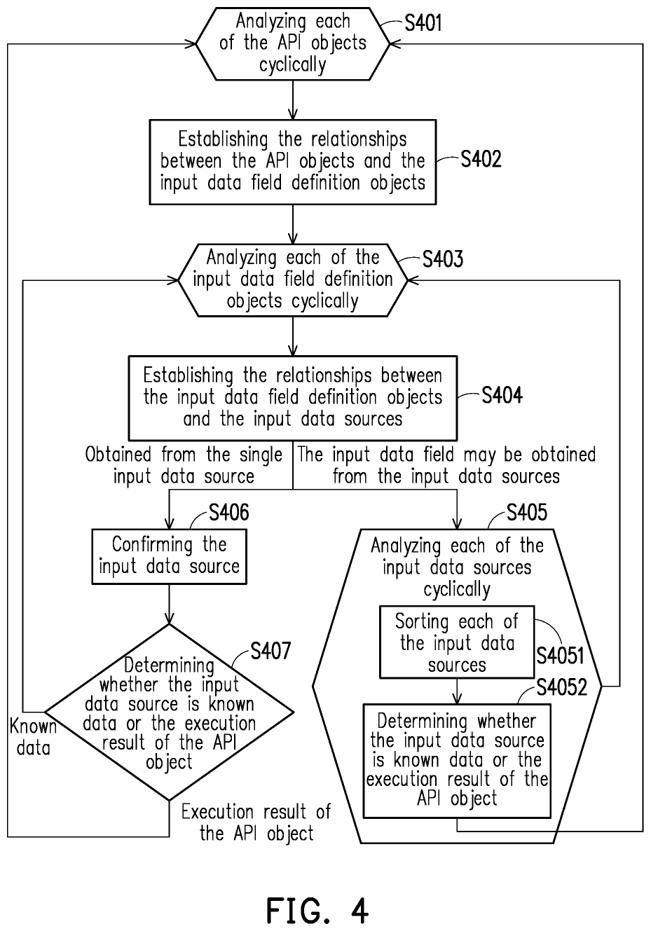

FIG. 4 is a flowchart of calling path planning analysis according to an embodiment of the disclosure. Referring to FIGS. 1 and 4, the embodiment describes in detail the calling path planning analysis process of the calling route planning module 122. In step S401, the calling route planning module 122 may cyclically analyze each of the API objects. In step S402, the calling route planning module 122 may establish the relationships between the API objects and the input data field definition objects. In step S403, the calling route planning module 122 may cyclically analyze each of the input data field definition objects. In step S404, the calling route planning module 122 may establish the relationships between the input data field definition objects and the input data sources. When the input data field may be obtained from the input data sources, the calling route planning module 122 may execute step S405. When the input data field may be obtained from the single input data source, the calling route planning module 122 may execute step S406.

In step S405, the calling route planning module 122 may cyclically analyze each of the input data sources until the analyses of all of the input data sources are completed, and steps S403 to S405 are executed cyclically until the analyses of all of the input data fields are completed. In step S4051, the calling route planning module 122 may sort each of the input data sources. In step S4052, the calling route planning module 122 may determine whether the input data source of the input data field is known data or the execution result of the API object. When the input data source of the input data field is known data, the next input data source is analyzed. When the input data source of the input data field is the execution result of the next API object, step S401 is executed to analyze the next API object.

In step S406, the calling route planning module 122 may confirm the input data source. In step S407, the calling route planning module 122 may determine whether the input data source is known data or the execution result of the API object. When the input data source of the input data field is known data, steps S403 to S405 are cyclically executed until the analyses of all of the input data fields are completed. When the input data source of the input data field is the execution result of the next API object, step S401 is executed to analyze the next API object.

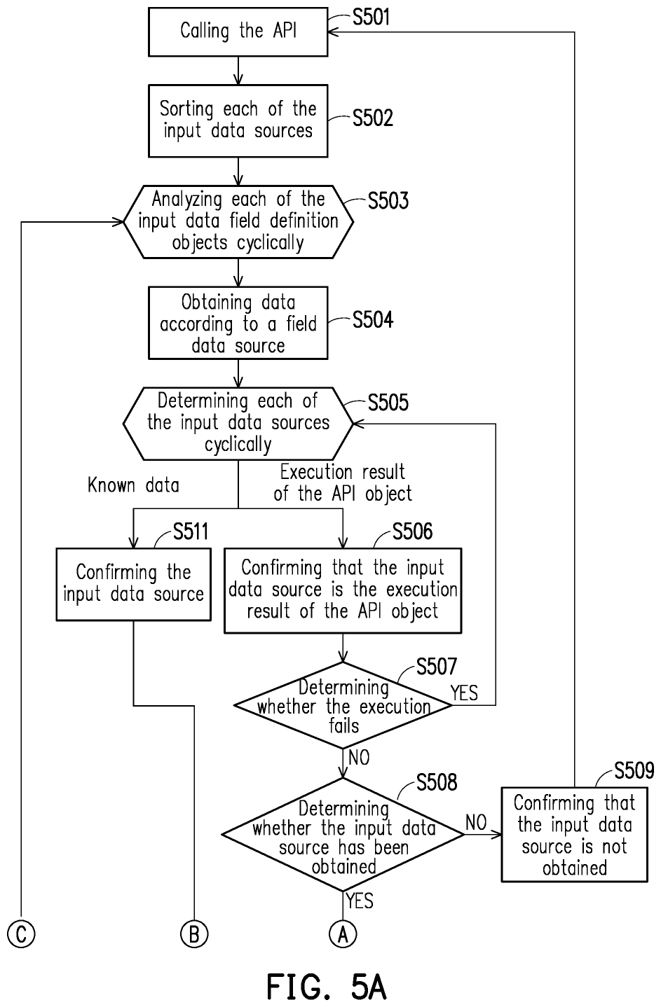

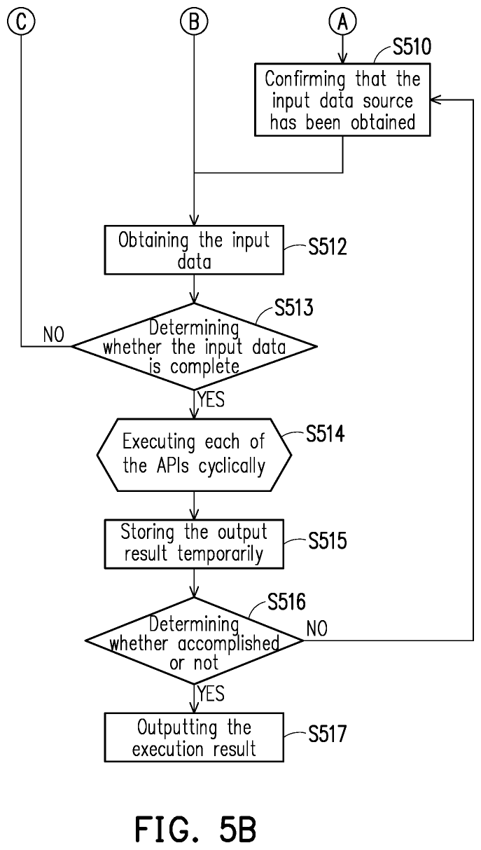

FIGS. 5A and 5B are flowcharts of execution logic of an embodiment of the disclosure. Referring to FIGS. 1, 5A, and 5B, the embodiment describes in detail the execution logic process of the execution module 123. In step S501, the execution module 123 may call the API. In step S502, the execution module 123 may confirm the input data fields to be assembled, and sort each of the input data sources. In step S503, the execution module 123 may cyclically analyze each of the input data field definition objects. In step S504, the execution module 123 may obtain data according to a field data source. In step S505, the execution module 123 may cyclically determine each of the input data sources. If the input data source is the execution result of the API object, the execution module 123 executes step S506 to confirm that the input data source is the execution result of the API object. If the input data source is known data, the execution module 123 executes step S511 to confirm that the input data source is the known data.

In step S507, the execution module 123 may determine whether the execution fails. If so, the execution module 123 executes step S505 to determine the next input data source. If not, the execution module 123 executes step S508 to determine whether the input data source has been obtained. If not, the execution module 123 executes step S509 to confirm that the input data source is not obtained, and executes step S501 to call the next API to try to obtain the input data source. If so, the execution module 123 executes step S510 to confirm that the input data source has been obtained.

In step S512, the execution module 123 may obtain the input data. In step S513, the execution module 123 may determine whether the input data is complete. If not, the execution module 123 executes step S503 to call the next API. If so, the execution module 123 executes step S514 to cyclically execute each of the APIs. In step S515, the execution module 123 may temporarily store the output result (output data) generated by the execution of the current API. In step S516, the execution module 123 may determine whether the current call is accomplished. If not, the execution module 123 may execute step S510 to continue to confirm the input data source and execute the next API. If so, the execution module 123 may execute step S517 to output the execution result (final output data).

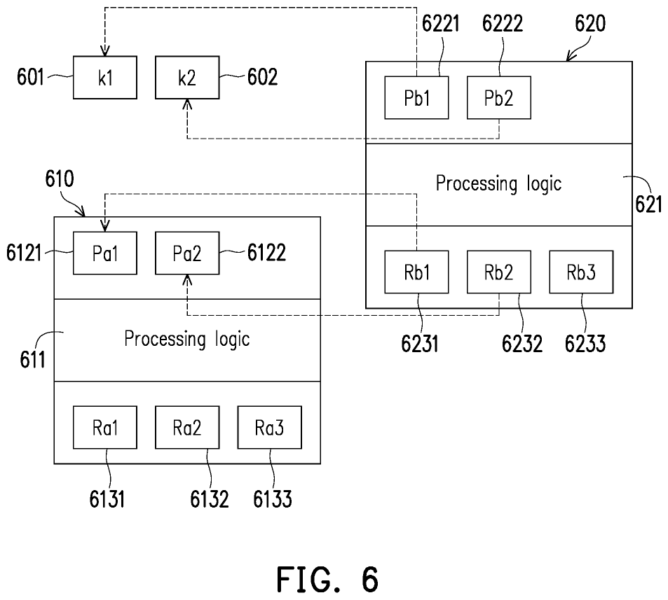

FIG. 6 is a schematic diagram of a calling model according to an embodiment of the disclosure. Referring to FIGS. 1 and 6, the embodiment exemplifies an execution manner of the execution module 123. The automated service arrangement and execution system 100 may receive the request data to execute an API 610. The data relationship obtaining and parsing module 121 may analyze the request data to create a calling model including the API 610 and an API 620. The calling route planning module 122 further establishes the calling path. The execution module 123 may sequentially call the API 610 and the API 620 according to the calling path. Specifically, first, the execution module 123 may execute the API 610. The execution module 123 may assemble input data 6121 (Pa1) of the API 610, and obtain data according to the field data source of the input data 6121 (Pa1). In this regard, since the input data 6121 (Pa1) comes from output data 6231 (Rb1) of the API 620, currently, no data is available. The execution module 123 may execute the API 620 to assemble input data 6221 (Pb1) of the API 620, and obtain data according to the field data source of the input data 6221 (Pb1). The execution module 123 may obtain data from known data 601 (k1) to complete the assembly of the input data 6221 (Pb1). In this regard, the execution module 123 may assemble input data 6222 (Pb2) of the API 620, and obtain data according to the field data source of the input data 6222 (Pb2). The execution module 123 may obtain data from known data 602 (k2) to complete the assembly of the input data 6222 (Pb2). In this way, the input data of the API 620 is complete, and the execution module 123 may call processing logic 621 of the API 620 to generate output data 6231 to 6233. The execution module 123 may temporarily store the output data 6231 to 6233 (Rb1 to Rb3).

Next, the execution module 123 may assemble the input data 6121 (Pa1) of the API 610. The execution module 123 may obtain the input data 6121 (Pa1) from the output data 6231 (Rb1) of the API 620 to complete the assembly of the input data 6121 (Pa1). The execution module 123 may assemble input data 6122 (Pa2) of the API 610, and obtain data according to the field data source of the input data 6122 (Pa2). The execution module 123 may obtain the input data 6122 (Pa2) from the output data 6232 (Rb2) of the API 620 to complete the assembly of the input data 6122 (Pa2). In this way, the input data of the API 610 is complete, and the execution module 123 may execute processing logic 611 of the API 610 to generate output data 6131 to 6133 (Ra1 to Ra3). The execution module 123 may output the output data 6131 to 6133 (Ra1 to Ra3) to complete the data request of this time.

In summary, the automated service arrangement and execution system and the method thereof of the disclosure may automatically create the calling model that has one or more API objects and the API according to the request data, and may automatically analyze the calling model to establish the calling path. The automated service arrangement and execution system and the method thereof of the disclosure may automatically execute the calling model according to the calling path, so as to effectively generate the execution result of the API.

Finally, it should be noted that the above embodiments are only used to illustrate the technical solutions of the disclosure, but not to limit the technical solutions of the disclosure. Although the disclosure has been described in detail with reference to the foregoing embodiments, those of ordinary skill in the art should understand that the technical solutions described in the foregoing embodiments may still be modified, or some or all of the technical features thereof may be equivalently replaced. However, these modifications or substitutions do not make the essence of the corresponding technical solutions deviate from the scope of the technical solutions of the embodiments of the disclosure.

What is claimed is:

1. An automated service arrangement and execution system, comprising:
a storage device, storing a plurality of modules; and
a processor, coupled to the storage device, executing the plurality of modules, and receiving request data for executing an application programming interface (API), wherein the plurality of modules comprise a data relationship obtaining and parsing module, a calling route planning module, and an execution module,
wherein the data relationship obtaining and parsing module creates a calling model according to the request data, the calling model comprises a plurality of API objects and the API, and the calling route planning module establishes a calling path according to the plurality of API objects and relationship information between a respective plurality of input data of the API and a plurality of input data sources,
wherein the execution module executes the plurality of API objects and the API in the calling model according to the calling path, so as to generate an execution result of the API.

2. The automated service arrangement and execution system according to claim 1, wherein the data relationship obtaining and parsing module comprises:
a request data analysis unit, which analyzes known data to obtain an attribute field, and provides the attribute field to a data relationship management unit with business meaning equivalence to obtain a data relationship between the attribute field and the API;
a data parsing unit, which analyzes the data relationship for executing the API to identify respective API object and input structure definitions of the plurality of API objects and API object input parameter and data source relationships; and
an application program execution object builder unit, which constructs the plurality of API objects according to the respective API object and input structure definitions of the plurality of API objects and the API object input parameter and data source relationships.

3. The automated service arrangement and execution system according to claim 2, wherein the API object and input structure definitions comprise at least one of an API object name, an API access method, an API access address, an input parameter structure, an input parameter data hierarchy, and an input parameter field name.

4. The automated service arrangement and execution system according to claim 2, wherein the API object input parameter and data source relationships comprise at least one of an API object name, a subordinate relationship between an input parameter field and the API object, a name of the input parameter field, a hierarchical description of the input parameter field in an input parameter structure, a field name of data corresponding to the input parameter field in a data source, a data source name, and a hierarchical description in the data source of a field in the data source.

5. The automated service arrangement and execution system according to claim 2, wherein the API object and input structure definitions comprise an API name of the API object, an API access method, an API access address, and an API input data structure.

6. The automated service arrangement and execution system according to claim 5, wherein the input data structure comprises a hierarchy of the input data, a field name of the input data, and a hierarchical subordinate relationship between fields.

7. The automated service arrangement and execution system according to claim 2, wherein the API object input parameter and data source relationships comprise an API name of the API object, a subordinate relationship between an API input data field and the API object, an API input data name, a hierarchical description of the API input data field in an input data structure, a field name of the API input data field in the corresponding input data resource, a name of the input data source, and a hierarchical description in the input data source of a field in the input data source.

8. The automated service arrangement and execution system according to claim 1, wherein the calling route planning module comprises:
an input data and input data source relationship builder unit, which establishes relationships between the plurality of API objects and input data field definition objects and relationships between the input data field definition objects and the plurality of input data sources according to the respective API object and input structure definitions of the plurality of API objects and the API object input parameter and data source relationships; and
an execution path planning logic unit, which sorts the plurality of input data sources according to a preset rule to establish the calling path.

9. The automated service arrangement and execution system according to claim 1, wherein the execution module comprises:
an execution data management unit, which stores the request data, and stores a plurality of output data generated by the plurality of API objects and the API;
an API object execution scheduler unit, which schedules the plurality of API objects according to the calling path;
an API object input data construction unit, which constructs a plurality of input data fields according to the plurality of API objects; and
an API execution agent unit, which initiates calls of the plurality of API objects and the API, and collects the plurality of output data generated by the plurality of API objects and the API.

10. The automated service arrangement and execution system according to claim 1, wherein the plurality of API objects and the API are a plurality of different business APIs, and the execution result of the API is business data.

11. An automated service arrangement and execution method, comprising:
receiving request data for executing an application programming interface (API);
creating, by a data relationship obtaining and parsing module, a calling model according to the request data, wherein the calling model comprises a plurality of API objects and the API;
establishing, by a calling route planning module, a calling path according to the plurality of API objects and relationship information between a respective plurality of input data of the API and a plurality of input data sources; and
executing, by an execution module, the plurality of API objects and the API in the calling model according to the calling path, so as to generate an execution result of the API.

12. The automated service arrangement and execution method according to claim 11, wherein creating, by the data relationship obtaining and parsing module, the calling model according to the request data comprises:
performing an analysis, by a request data analysis unit, to obtain an attribute field, and providing the attribute field to a data relationship management unit with business meaning equivalence to obtain a data relationship for executing the API;
analyzing, by a data parsing unit, the data relationship for executing the API to identify respective API object and input structure definitions of the plurality of API objects and API object input parameter and data source relationships; and
constructing, by an application program execution object builder unit, the plurality of API objects according to the respective API object and input structure definitions of the plurality of API objects and the API object input parameter and data source relationships.

13. The automated service arrangement and execution method according to claim 12, wherein the API object and input structure definitions comprise at least one of an API object name, an API access method, an API access address, an input parameter structure, an input parameter data hierarchy, and an input parameter field name.

14. The automated service arrangement and execution method according to claim 12, wherein the API object input parameter and data source relationships comprise at least one of an API object name, a subordinate relationship between an input parameter field and the API object, a name of the input parameter field, a hierarchical description of the input parameter field in an input parameter structure, a field name of data corresponding to the input parameter field in a data source, a data source name, and a hierarchical description in the data source of a field in the data source.

15. The automated service arrangement and execution method according to claim 12, wherein the API object and input structure definitions comprise an API name of the API object, an API access method, an API access address, and an API input data structure.

16. The automated service arrangement and execution method according to claim 15, wherein the input data structure comprises a hierarchy of the input data, a field name of the input data, and a hierarchical subordinate relationship between fields.

17. The automated service arrangement and execution method according to claim 12, wherein the API object input parameter and data source relationships comprise an API name of the API object, a subordinate relationship between an API input data field and the API object, an API input data name, a hierarchical description of the API input data field in an input data structure, a field name of the API input data field in the corresponding input data resource, a name of the input data source, and a hierarchical description in the input data source of a field in the input data source.

18. The automated service arrangement and execution method according to claim 11, wherein establishing, by the calling route planning module, the calling path according to the plurality of API objects and the relationship information between the respective plurality of input data of the API and the plurality of input data sources comprises:
establishing, by an input data and input data source relationship builder unit, relationships between the plurality of API objects and input data field definition objects and relationships between the input data field definition objects and the plurality of input data sources according to the respective API object and input structure definitions of the API objects and the API object input parameter and data source relationships; and
sorting, by an execution path planning logic unit, the plurality of input data sources according to a preset rule to establish the calling path.

19. The automated service arrangement and execution method according to claim 11, wherein executing, by the execution module, the plurality of API objects and the API in the calling model according to the calling path comprises:
storing, by an execution data management unit, the request data, and storing a plurality of output data generated by the plurality of API objects and the API;
scheduling, by an API object execution scheduler unit, the plurality of API objects according to the calling path;
constructing, by an API object input data construction unit, a plurality of input data fields according to the plurality of API objects; and
initiating, by an API execution agent unit, calls of the plurality of API objects and the API, and collecting the plurality of output data generated by the plurality of API objects and the API.

20. The automated service arrangement and execution method according to claim 11, wherein the plurality of API objects and the API are a plurality of different business APIs, and the execution result of the API is business data.
